(19) United States
(12) Patent Application Publication
(10) Pub. No.: US 2016/0223175 A1
(43) Pub. Date: Aug. 4, 2016

(54) PORTABLE HIGH POWER AC LIGHTING

(71) Applicant: DIVAS TECHNOLOGY CO., LTD., Taoyuan City 330 (TW)

(72) Inventor: FU-I YANG, TAOYUAN CITY 330 (TW)

(21) Appl. No.: 14/612,435

(22) Filed: Feb. 3, 2015

(51) Int. Cl. F21V 23/00; F21V 31/00; F21V 23/04; F21L 4/08

(52) U.S. Cl. CPC F21V 23/009; F21L 4/085; F21V 31/005; F21V 23/0428

(57) ABSTRACT

A portable high power AC lighting comprises a body with an opening at the top thereof, a bulb holder disposed inside the opening, an AC bulb above the bulb holder, a light cover fixed above the opening for covering the AC bulb, and a control circuit board disposed therein for recharging and saving the direct currents rapidly and repeatedly in the series lithium battery pack to provide the AC power for the AC bulb by an AC supply unit, forming an AC lighting device of high-brightness with a 360° lighting angle that can be held and carried easily like a bright torch. Also, the present invention uses a standard AC LED/PL bulb which is common in households, making it much easier to replace the bulb when needed. Hence, the present invention has the problems in the prior art solved and provides a high power but energy saving lighting device for continuous usage.

### BACKGROUND OF THE INVENTION

1. Field of the Invention

The present invention relates to a portable high power AC lighting, particularly to one that is easy for holding and carrying and that has a 360° lighting angle with high-brightness.

2. Description of the Related Art

FIG. 1 is a perspective view of a conventional flashlight 100, comprising a body 101, a front head 102 arranged at the front of the body 101, and a small bulb 103 disposed inside the font head 102. It has batteries (not shown) disposed inside the body 101 to supply DC power for the small bulb 103. It is common among households due to its feature as easy carrying. However, the flash light 100 can only output low power electricity with neither a small bulb 103 nor a LED bulb, and the lighting angle θ is restricted as well. Thus, when it comes to occasions requiring high-brightness such as emergency rescue, traffic warning, and some working places, it is still inadequate.

FIG. 2 is a perspective view of a conventional working light 200, comprising an AC bulb 201, a protecting wire net 202, a hook 203, an extended line 205 and an AC plug 206. It has the hook 203 to be hung up on an object 204 to provide lighting in working places. Such working lights have AC power to provide the AC bulb and consequently are able to output high power electricity that would satisfy the needs in working places like repair shops and garages. However, the AC power has to be acquired by connecting the extended line 205 and the AC plug 206 with main supply, and the extended line 205 may cause obstacles and inconveniences in the working process; more importantly, it places a restriction of environment. Therefore, such structure is still inadequate as well.

### SUMMARY OF THE INVENTION

It is a primary object of the present invention to provide a portable high power AC lighting that has the DC energy in the series lithium battery pack inside the body thereof converted into AC energy for output, so as to form a lighting device of high-brightness with a 360° lighting angle that can solve the problems in the prior art and meanwhile has a portable feature and an AC bulb providing brighter luminance.

In order to achieve the objects, the present invention comprises a body arranged in a shape for holding with an installing space therein and an opening at the top thereof; a series lithium battery pack including a plurality of lithium batteries and disposed inside the installing space; at least one controlling circuit board disposed inside the installing space and electrically connected to the series lithium battery pack with a DC charging unit and an AC supply unit disposed thereon; a DC power input interface coupled to the controlling circuit board and arranged on the surface of the body uncovered; a bulb holder disposed inside the opening of the body and electrically connected to the controlling circuit board; an AC bulb, including a cap and a luminous body where the cap being mounted on the bulb holder, placing the luminous body above the opening and the AC bulb above the body; a light cover fixed above the opening in order to cover the AC bulb; said DC charging unit including a charging control loop with the input thereof coupled to the DC power input interface and a MCU coupled to said charging control loop with the positive and negative electrode separately coupled to the charging control loop and the MCU; and said AC supply unit including an output control loop with the input thereof coupled to the charging control loop and the positive electrode of the series lithium battery pack and coupled to the MCU as well for the output control loop to control the output of the direct currents, and a DC-AC converter with the input thereof coupled to the output control loop to convert direct currents to alternating currents and further provide the electricity for the AC bulb from the output terminal thereof; whereby the series lithium battery pack can restore DC energy and provide the electricity for the AC bulb via the AC supply unit, so as to form a portable high power AC lighting with a 360° lighting angle.

Furthermore, both electrodes of the series lithium battery pack are further coupled to a battery protection circuit and the negative electrode thereof is coupled to a current detector. The charging control loop of the DC charging unit is coupled to a constant voltage loop and a voltage regulator circuit, and the MCU is further coupled to a light signal display unit, a temperature controller and a switch button disposed on a corresponding first hollow hole arranged on the body and having a cover piece on the surface thereof.

In addition, the AC bulb is made of a compact fluorescent light bulb, a LED bulb, a PL energy saving light bulb, or a LED/PL fluorescent tube. The body of the present invention is assembled by two symmetrical housings with a groove along the joint surface for a water-proof rubber band to be disposed therein, making it water-proof; and a second hollow hole is arranged on the body in the corresponding position with the DC power input interface for it to be disposed therein, and the surface of the second hollow hole further includes a detachable water-proof pad. The light signal display unit thereof is further constructed by a plurality of arranged LED and light guiding tubes, and the body has a plurality of hollow holes corresponding to the position of the light signal display unit to emit the lights therefrom.

With the structures disclosed above, the present invention has the series lithium battery pack for recharge and saving the direct currents rapidly and repeatedly in order to provide the AC power for the AC bulb by an AC supply unit, forming a lighting device of high-brightness with a 360° lighting angle that can be held and carried easily like a bright torch. Additionally, the present invention uses a standard AC LED/PL bulb which is common in households, making it much easier to replace the bulb when needed. Hence, the present invention has the problems in the prior art solved and provides a high power but energy saving lighting device for continuous usage.

### BRIEF DESCRIPTION OF THE DRAWINGS

FIG. 1 is a perspective view of a conventional flashlight;

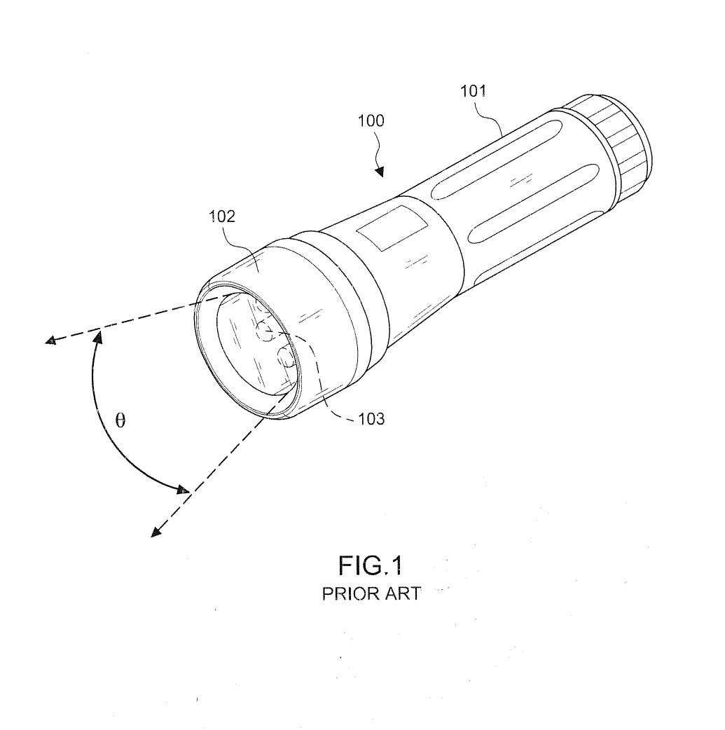

FIG. 2 is a perspective view of a conventional working light;

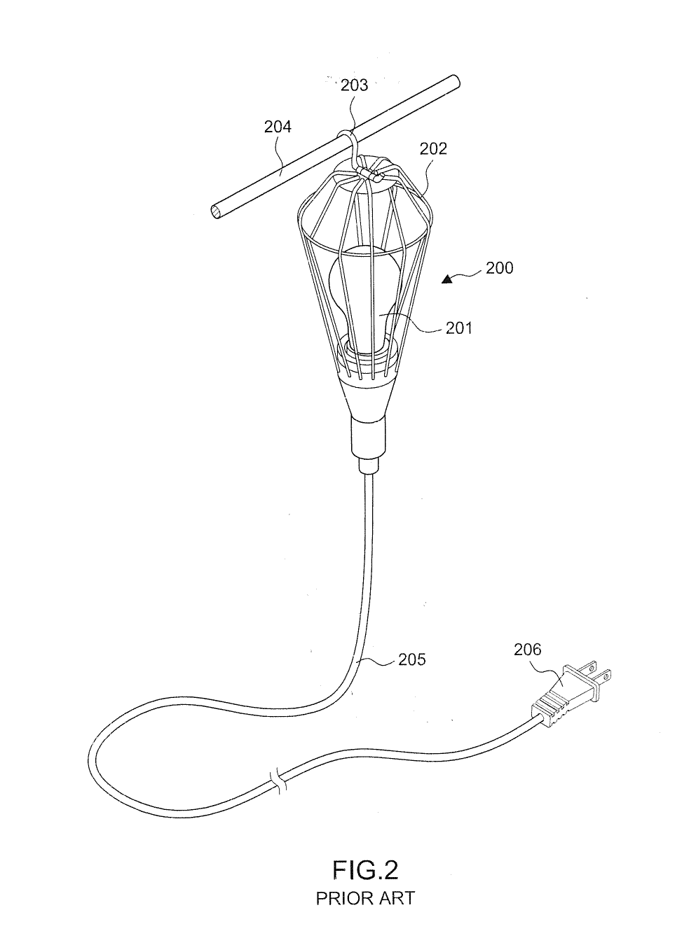

FIG. 3 is an exploded view of the present invention in an applicable embodiment;

FIG. 4 is an exploded view of the body and the bulb thereof in an applicable embodiment;

FIG. 5 is a perspective view of the present invention in an applicable embodiment;

FIG. 6 is a sectional view of the present invention in an applicable embodiment; and

FIG. 7 is a circuit block diagram of the present invention in an applicable embodiment.

### DETAILED DESCRIPTION OF THE PREFERRED EMBODIMENT

First of all, some certain words in this description and the subsequent claims referring to specific components shall be understandable for a skilled person in the art. In the following description and subsequent claims, the components are not distinguished by terms different from what other manufacturers may use but by functions, and the term ‘include’ and ‘comprise’ in the description and subsequent claims are referred to an open term that should be interpreted as ‘including, but not limited to.’ Besides, the term ‘couple’ includes both direct and indirect means of electrical connection.

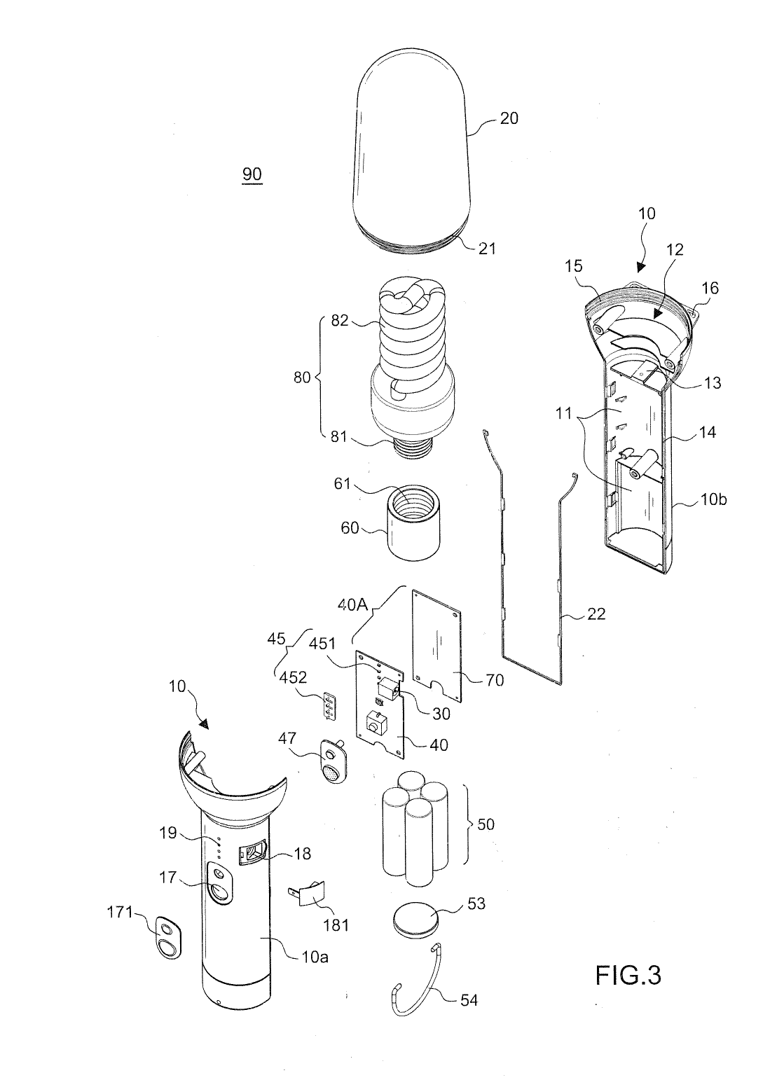

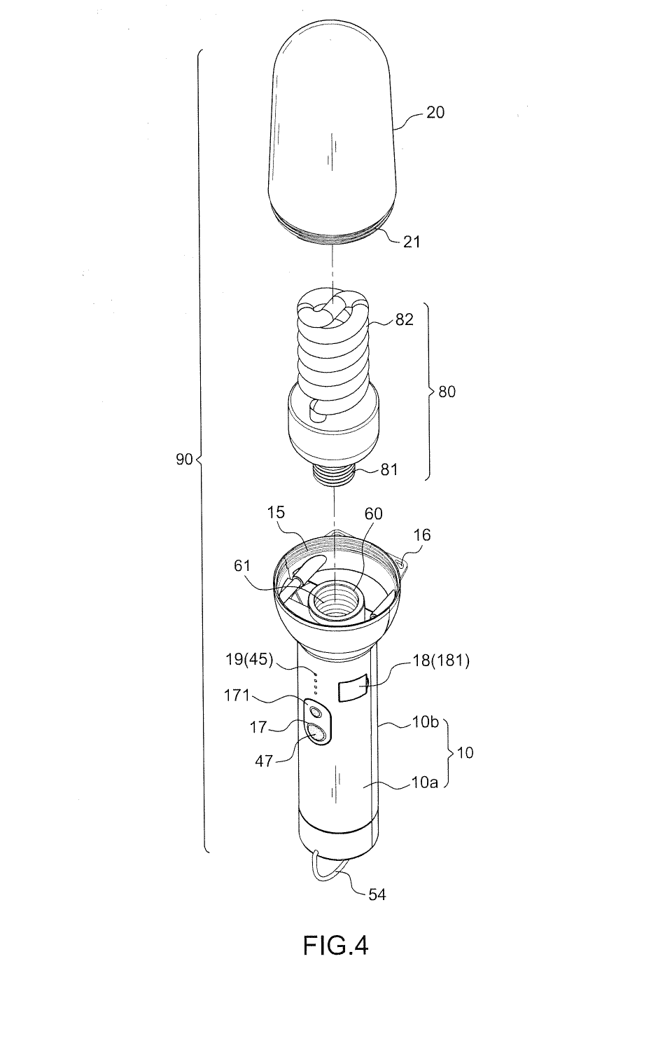

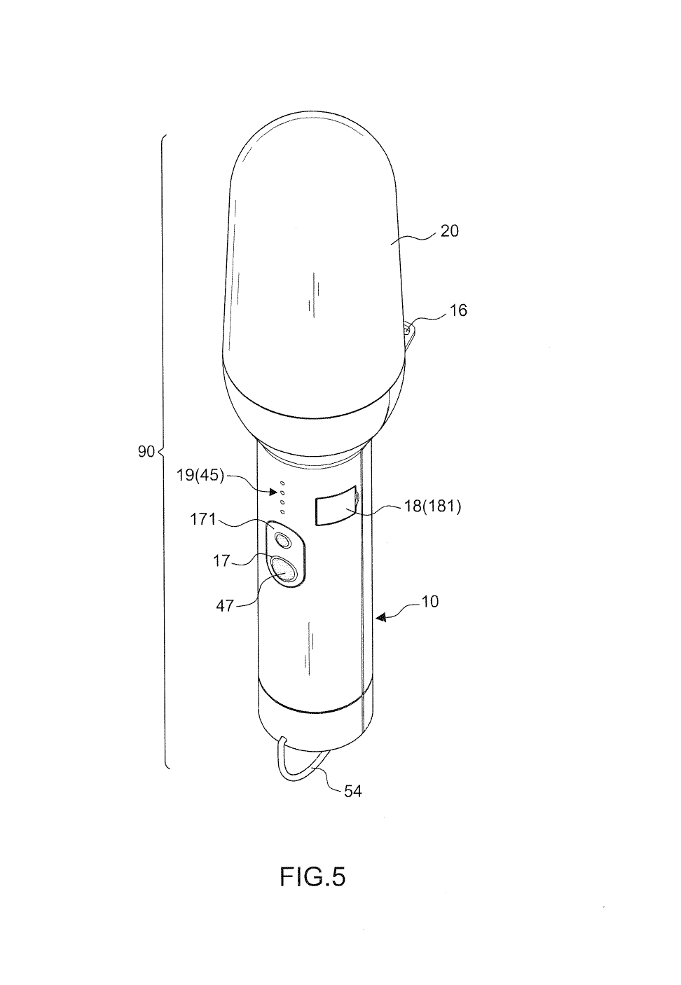

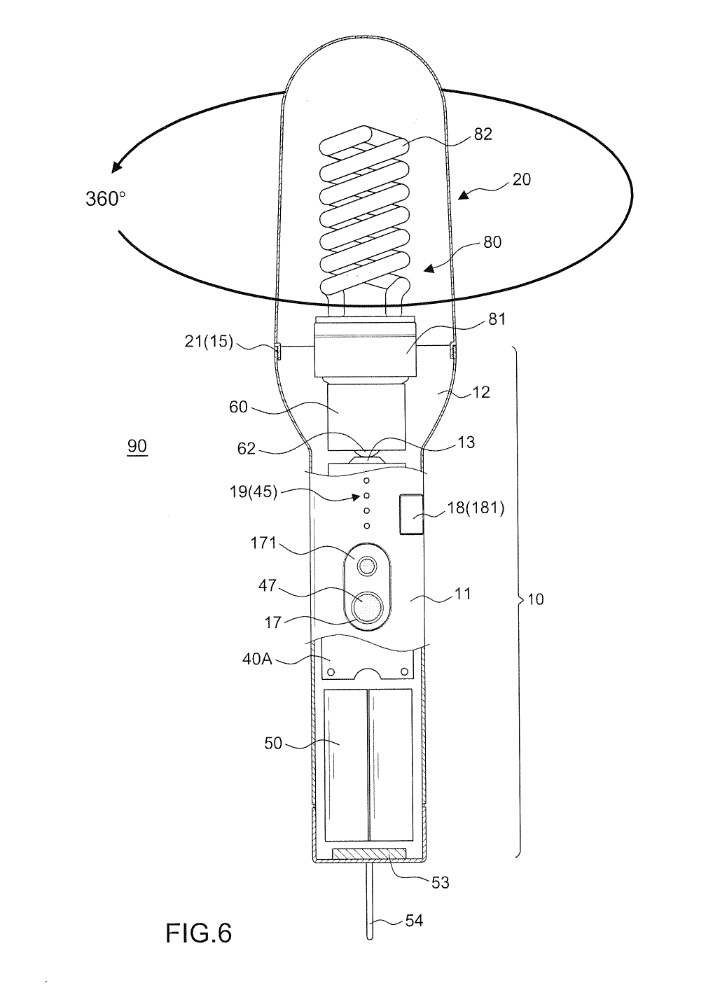

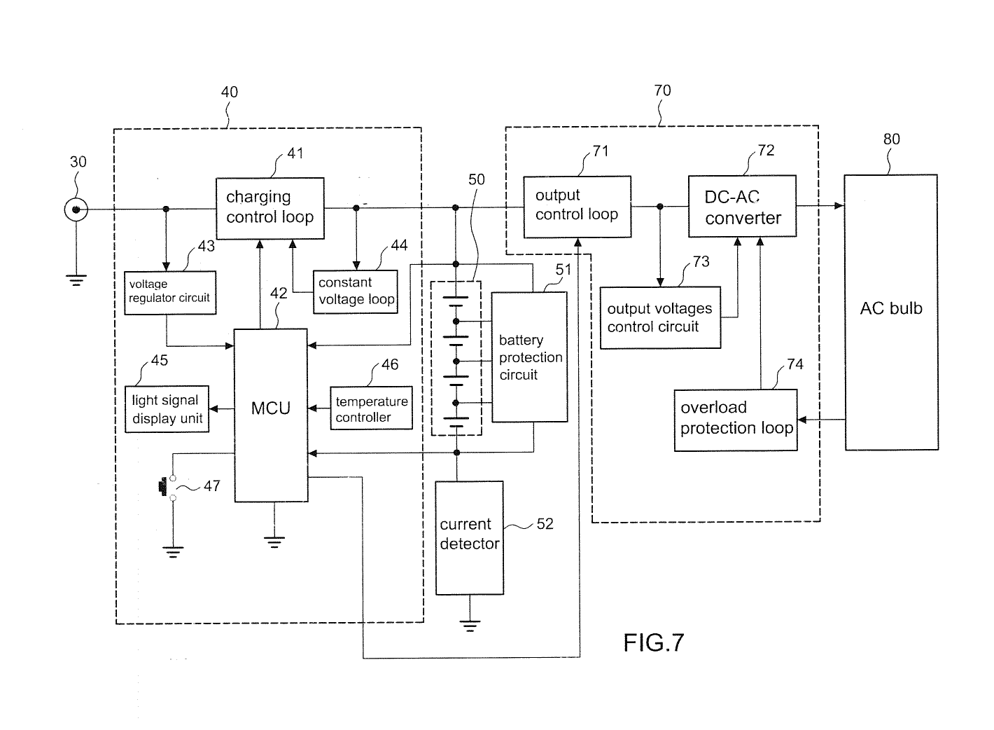

Referring to FIGS. 3-7, in an applicable embodiment, the present invention comprises a body 10, a series lithium battery pack 50, at least one control circuit board 40A, a bulb holder 60, an AC bulb 80 and a light cover 20.

The body 10 is arranged in a shape for holding with an installing space 11 arranged therein and an opening 12 at the top thereof; and the opening 12 has an electrode 13 arranged at the bottom. In this embodiment, the body 10 is assembled by two symmetrical housings 10a, 10b with a groove 14 along the joint surface for a water-proof rubber band 22 to be disposed therein, making the present invention water-proof. Moreover, the inner edge of the opening 12 has a first thread 15, and the body 10 has a tab 16 arranged aside, and a magnet 53 and a D ring 54 are arranged at the bottom thereof for attaching and hanging.

The series lithium battery pack 50 includes a plurality of lithium batteries and disposed inside the installing space 11. In this embodiment, the positive and negative electrodes thereof are further coupled to a battery protection circuit 51 and the negative electrode thereof is coupled to a current detector 52. The battery protection circuit 51 can protect the series lithium battery pack 50 from sudden electrical surge or unusual situation, and the current detector 52 can detect the charging status of the series lithium battery pack 50. In the embodiment, there is one set of series lithium battery pack 50, but it is not limited to such application. There could be more than one pack so that one of which can be disposed inside the installing space 11 for usage and the others can be full charged and available for carrying in case of the need; simply arranging a detachable cover on the body 10 in the corresponding position would allow the replacement of the series lithium battery pack 50.

The controlling circuit board 40A is disposed inside the installing space 11 and electrically connected to the series lithium battery pack 50. In the embodiment, there are a DC power input interface 30, a DC charging unit 40 and an AC supply unit 70 disposed on the controlling circuit board 40A. The DC power input interface 30 is coupled to the controlling circuit board 40A and is arranged on the surface of the body 10 uncovered. In this embodiment, a second hollow hole 18 is arranged on the body 10 in the corresponding position with the DC power input interface 30 for it to be disposed therein, and the surface of the second hollow hole 18 further includes a detachable water-proof pad 181 which is usually wedged therein to ensure the present invention being water-proof; only when the present invention needs charging would it be removed.

The bulb holder 60 is disposed inside the opening 12 of the body 10 and is electrically connected to the controlling circuit board 40A; in this embodiment, the bottom 62 of the bulb holder 60 is electrically connected to the electrode 13 of the bottom of the opening 12 in order to provide the AC power to the bulb holder 60 via the electrical contact 61.

The AC bulb 80 includes a cap 81 and a luminous body 82. The cap 81 is mounted on the electrical contact 61 of the bulb holder 60, placing the luminous body 82 above the opening 12 and the AC bulb 80 above the body 10. In the embodiment, the AC bulb 80 is made of a compact fluorescent lighting bulb and the cap 81 and the electrical contact 61 would be designed as a complementary spiral for screwing, but it is not limited to such application. It can also be a LED bulb, a PL energy saving light bulb, or a LED/PL fluorescent tube, and the cap 81 and the electrical contact 61 would also be designed as a complementary structure as well.

The light cover 20 is fixed above the opening 12 in order to cover the AC bulb 80, and it could be made of light-transmitting PC materials. In the embodiment, the bottom edge of the light cover 20 has a second thread 21 to be screwed with the first thread 15 for the light cover 20 to be fixed above the opening 12 quickly and to cover the AC bulb 80; it is also convenient for replacing the AC bulb 80. In this way, the body 10 and the light cover 20 are both sealed and water-proof.

The DC charging unit 40 is disposed on the control circuit board 40A and includes a charging control loop 41 with the input thereof coupled to the DC power input interface 30, and a MCU 42 coupled to said charging control loop 41 with the positive and negative electrode of the series lithium battery pack 50 separately coupled to the charging control loop 41 and the MCU 42. In this embodiment, the charging control loop 41 of the DC charging unit 40 is further coupled to a constant voltage loop 44 and a voltage regulator circuit 43, and the MCU 42 is further coupled to a light signal display unit 45, a temperature controller 46 and a switch button 47 disposed on a corresponding first hollow hole 17 arranged on the body 10 and having a cover piece 171 on the surface thereof. Furthermore, the light signal display unit 45 is further constructed by a plurality of arranged LED 451 and light guiding tubes 452, and the body 10 has a plurality of hollow holes 19 corresponding to the position of the light signal display unit 45 to emit the lights therefrom.

The AC supply unit 70 is disposed on the control circuit board 40A and includes an output control loop 71 and a DC-AC converter 72. The output control loop 71 has the input thereof coupled to the charging control loop 41 and the positive electrode of the series lithium battery pack 50; it is also coupled to the MCU 42 as well for the output control loop 71 to control the output of the direct currents; and the DC-AC converter 72 has the input thereof coupled to the output control loop 71 to convert direct currents from the DC charging unit 40 to alternating currents and further provide the electricity for the AC bulb 80 from the output terminal thereof. In the embodiment, the AC supply unit 70 further includes an output voltages control circuit 73 coupled in-between the output control loop 71 and the DC-AC converter 72 for controlling the output voltages, and an overload protection loop 74 coupled to the DC-AC converter 72 and the AC bulb 80;

whereby the series lithium battery pack 50 can restore DC energy and provide the electricity for the AC bulb 80 via the AC supply unit 70, so as to form a portable high power AC lighting 90 with a 360° lighting angle that solves the problems in the prior art and meanwhile has a portable feature with brighter luminance as a flashlight.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A portable high power AC lighting, comprising
a body arranged in a shape for holding with an installing space therein and an opening at the top thereof;
a series lithium battery pack including a plurality of lithium batteries and disposed inside the installing space;
at least one controlling circuit board disposed inside the installing space and electrically connected to the series lithium battery pack with a DC charging unit and an AC supply unit disposed thereon;
a DC power input interface coupled to the controlling circuit board and arranged on the surface of the body uncovered;
a bulb holder disposed inside the opening of the body and electrically connected to the controlling circuit board;
an AC bulb, including a cap and a luminous body where the cap being mounted on the bulb holder, placing the luminous body above the opening and the AC bulb above the body;
a light cover fixed above the opening in order to cover the AC bulb;
said DC charging unit including a charging control loop with the input thereof coupled to the DC power input interface and a MCU coupled to said charging control loop with the positive and negative electrode of the series lithium battery pack separately coupled to the charging control loop and the MCU; and
said AC supply unit including an output control loop with the input thereof coupled to the charging control loop and the positive electrode of the series lithium battery pack and coupled to the MCU as well for the output control loop to control the output of the direct currents, and a DC-AC converter with the input thereof coupled to the output control loop to convert direct currents to alternating currents and further provide the electricity for the AC bulb from the output terminal thereof;
whereby the series lithium battery pack can restore DC energy and provide the electricity for the AC bulb via the AC supply unit, so as to form a portable high power AC lighting with a 360° lighting angle.

2. The portable high power AC lighting as claimed in claim 1, wherein the positive and negative electrode of the series lithium battery pack are further coupled to a battery protection circuit and the negative electrode thereof is coupled to a current detector.

3. The portable high power AC lighting as claimed in claim 1, wherein the charging control loop of the DC charging unit is further coupled to a constant voltage loop and a voltage regulator circuit, and the MCU is further coupled to a light signal display unit, a temperature controller and a switch button disposed on a corresponding first hollow hole arranged on the body and having a cover piece on the surface thereof.

4. The portable high power AC lighting as claimed in claim 1, wherein the AC bulb is made of a compact fluorescent light bulb, a LED bulb, a PL energy saving light bulb, or a LED/PL fluorescent tube.

5. The portable high power AC lighting as claimed in claim 1, wherein the body is assembled by two symmetrical housings with a groove along the joint surface for a water-proof rubber band to be disposed therein, making the present invention water-proof.

6. A portable high power AC lighting as claimed in claim 1, wherein a second hollow hole is arranged on the body in the corresponding position with the DC power input interface for it to be disposed therein, and the surface of the second hollow hole further includes a detachable water-proof pad.

7. A portable high power AC lighting as claimed in claim 1, wherein the light signal display unit is further constructed by a plurality of arranged LED and light guiding tubes, and the body has a plurality of hollow holes corresponding to the position of the light signal display unit to emit the lights therefrom.

8. A portable high power AC lighting as claimed in claim 1, wherein the body has a tab arranged aside, and a magnet and a D ring are arranged at the bottom thereof.

9. A portable high power AC lighting as claimed in claim 1, wherein the AC supply unit further includes an output voltages control circuit coupled in-between the output control loop and the DC-AC converter, and an overload protection loop coupled to the DC-AC converter and the AC bulb.

10. A portable high power AC lighting as claimed in claim 1, wherein the series lithium battery pack can be more than 1 pack so that one of which can be disposed inside the installing space for usage and the others can be full charged and available for carrying in case of the need.
